(19) United States
(12) Patent Application Publication
(10) Pub. No.: US 2025/0049003 A1
(43) Pub. Date: Feb. 13, 2025

(54) Pump and cleaning system for fish farm

(71) Applicant: Westcon Yards AS, OLENSVAG (NO)

(72) Inventor: Arne Matre, Olen (NO)

(73) Assignee: Westcon Yards AS, OLENSVAG (NO)

(21) Appl. No.: 18/710,626

(22) PCT Filed: Nov. 23, 2022
(86) PCT No.: PCT/EP2022/082965

§ 371 Date: May 16, 2024

(30) Foreign Application Priority Data
Nov. 23, 2021 (NO) 20211426

(51) Int. Cl. A01K 61/60; A01K 61/10; A01K 63/04

(52) U.S. Cl. CPC A01K 61/60; A01K 61/10; A01K 63/04

(57) ABSTRACT

The present invention relates to a modular offshore fish farm (1), where the fish farm comprises one or more closed net cages (2) and a service unit S, each closed net cage being supported by a buoyant body (3) which is configured for floating in a body of water, wherein each closed net cage is configurated for moving vertically in the body of water relative to the buoyant body, each buoyant body further comprising a number of buoyant elements (4) and connecting means for connecting to an adjacent buoyant body, at least one buoyant element (4) of a buoyant body being arranged to be ballastable/deballastable and at least one buoyant element comprises one or more pipes (16, 17) for supply of fresh sea water and drainage of sea water from the closed net cage and a pumping and cleaning system connected to the one or more pipes.

### TECHNICAL FIELD

The present invention relates generally to the field of water treatment systems and more particularly to such systems for use in conjunction with aquaculture.

### BACKGROUND

Industrial fish farming has long been a major industry in many countries, and both the size and number of fish farms have grown considerably. The vast majority of fish cages used commercially are open cages located in the sea and where the fish that are raised are separated from the surroundings by a single layer of seine net that hangs like a large cylinder in the sea, closed in its bottom but open at the top. The net hangs from buoyancy elements, which form a floating ring on the surface. Under ideal conditions, this works well, but it is exposed to damage and loss of fish during storms and provides little protection against algae and not least salmon lice.

Existing facilities also contaminate the seabed under the facilities and the surrounding areas, because they lack effective solutions for collecting waste from fodder faeces.

Due to the disadvantages mentioned, a number of measures have been proposed to overcome these problems or disadvantages, such as moving the entire facilities ashore or using facilities that are more closed and can provide better protection against one or more of the mentioned disadvantages. So far, no proposals have been made that have proved sufficiently simple and affordable to realize that they to significant extent have been able to compete with existing facilities, despite the fact that they technically show advantages over the open cages.

In order to increase the production of seafood, several new fishery concepts with the potential to be used in the open sea have been proposed. Unlike the flexible floating rings widely used in currently operating fish farms, these new concepts make use of rigid support structures to withstand harsh environmental loads.

For instance, a rigid semi-submersible fish farm is designed, where the concept combines the technology in the field of aquaculture with the offshore oil and gas development technology. The design includes palisade supports, floating body units and a loose mooring system. The fishing nets are pulled tightly and fixed to the supports to avoid deformation in the water flow.

Other have proposed another rigid semisubmersible fish farm for unshielded sea areas, which contains two buoys that are connected by vertical and diagonal brackets. Cages of the fish farm are fully submerged in the sea to avoid large wave loads near the water surface, and an underwater air bag is designed to provide air. It should be noted that this concept uses the conventional gravity cage, which relies on bottom ballasts to maintain the volume. Such cages encounter bigger deformation in the high-speed water flow in an unshielded area than in a shielded area. This could threaten the health of fish. In addition, there are also challenges with the use of the underwater air bag.

In addition to the technology of open cages, closed fish farms are also proposed., for instance an oval fish farm. This design mainly considers that the living environment is easier to control in closed units. For instance, the possibility of sea lice infection is expected to be smaller than that in the open cages.

Escaping fish may also be avoided through such a concept. However, because of the complexity of control system and cabin structures used, the cost of such an oval fish farm is expected to be very high. In addition, due to its huge enclosed space and waterline area, the oval structure may suffer from huge environmental loads and internal impacts. As a result, oval structures are difficult to use in unshielded sea areas.

NO344177 B1 relates to a closed waiting cage for storing slaughter fish, where the cage is vertically movable relative to surrounding water, and where the cage comprises one or more buoyancy chambers extending vertically in the cage for ballasting and deballasting a buoyancy medium in the form of water. The invention also relates to a cage construction comprising a number of closed waiting cages arranged in a framework.

NO 343353 B1 relates to floating plants for treatment and breeding of marine organisms, where the floating plant comprises an elongate floating structure equipped with several adjacent arranged cages for rearing the marine organisms, as well as outriggers which accommodate the cages, where the floating structure is a barge which is firmly anchored to the seabed, and that the outriggers which accommodate the cages are attached to the hull side of the barge. There is also mentioned an inspection and de-lice module for use in a floating plant for breeding marine organisms, where the inspection and de-lice module are arranged for placement in one or more cages which are part of the floating plant and wherein the inspection and de-lice module comprises several channels through which the marine organisms can swim.

NO 342778 B1 relates to floating plant, where the floating plant comprises a container and a mooring element provided with respective guide elements. The guide elements have a mutual complementary shape such that the container and the mooring element may move freely with respect to each other in directions that coincide with the container central axis. A plurality of elongated buoyancy elements are arranged on the container outside and arranged between the container bottom end and the container upper end, preferably parallel with the container central axis. The container may be transported to the installation site, floating in the water and stabilized by means of the buoyancy elements. The mooring element may be transported to the installation site, either in one piece or on several pieces and mounted such that it surrounds a portion of the container. The container is raised and lowered in the body of water by controlling the amount of water in the container.

There is thus a need for alternatives to today's fish fishing farms, or at least supplementary solutions for fish farms.

### SUMMARY OF THE INVENTION

An object of the present invention is to remedy or reduce at least one of the drawbacks of the prior art or at least provide a useful alternative to the prior art.

It is a further object to provide a fish farm which provides good security against escape and which has an inherent ability of protecting fish against lice and against algae in the event of strong algae growth, and which pollutes the environment to a lesser extent.

These objects are achieved according to the present invention with a modular offshore fish farm comprising a number of net cages and corresponding buoyant bodies as defined in the independent claim 1. Further embodiments of the invention are defined in the dependent claims.

The present invention relates to a modular offshore fish farm, where the modular offshore fish farm comprises one or more closed net cages and a service unit, each closed net cage being supported by a buoyant body which is configured for floating in a body of water, wherein each closed net cage is configurated for moving vertically in a body of water relative to the buoyant body by changing the buoyancy of the closed net cage by changing the amount of water inside the closed net cage, each buoyant body further comprising a number of buoyant elements and connecting means for connecting to an adjacent buoyant body, at least one buoyant element of a buoyant body being arranged to be ballastable/deballastable and at least one buoyant element comprises one or more pipes for supply of sea water and drainage of sea water from the closed net cage and a pumping and cleaning system connected to the one or more pipes.

In one aspect, when the closed net cage is to be lowered relative to the buoyant body, then an amount of water pumped into the closed net cage will be greater than an amount of water pumped or drained out of the closed net cage.

In one aspect, when the closed net cage is to be lifted relative to the buoyant body, then an amount of water pumped or drained out of the closed net cage will be greater than an amount of water pumped into the closed net cage.

The modular offshore fish farm may, in one embodiment, comprise a service barge, a service unit, or the like, where the service barge or service unit may be connected to one or more of the buoyant elements of the buoyant body in order to perform and/or support different which is/are to be done at the modular fish farm. According to one aspect, the service barge may then be equipped, for instance, with a building, such as a living quarter, different equipment, such as pump(s), silo(s) for fish food, maintenance equipment, cleaning equipment, oxygenation system(s) or the like.

Each closed net cage of the modular offshore fish farm may, for instance, be made from a metal, a composite material, or a combination of these.

According to one embodiment, the buoyant elements may be connected to each other through welding, bolts or the like. Furthermore, each buoyant element may, on one side facing an adjacent buoyant element, be provided with a tongue and an opposite side of the buoyant element may be provided with a groove. The adjacent buoyant element facing the side of the buoyant element provided with the tongue, may then on this side be provided with a groove having a corresponding form to the tongue, while an opposite side of the buoyant element may be provided with a groove which is to be connected with a tongue of a following buoyant element.

According to one aspect, at least one of the number of buoyant elements of one buoyant body may comprise a ballasting and deballasting system, where such a system may be used to position the buoyant body in a desired position in the body of water. Furthermore, at least one of the number of buoyant elements of one buoyant body may comprise a pipe or conduit arrangement for one or more inlets and one or more outlets for water, pump(s), filter(s) and the like.

According to one embodiment, each closed net cage may comprise an annular shaped upper portion with substantially vertical walls and a conical bottom portion.

According to one aspect, a hose may be connected to the conical bottom portion of the closed net cage through one end, while an opposite end of the hose may be connected to a pipe or tube element of a buoyant element.

The pumping and cleaning system may comprise one or more pumps, where the one or more pumps may be arranged in one buoyant element, more than one buoyant element and/or the service vessel.

Furthermore, the pumping and cleaning system may comprise one or more filtering units.

The modular fish farm may, according to one embodiment, also comprise a chute, duct, channel, or the like, where the chute, duct or channel may be used to transport the fish from a closed net cage and to a vessel or the like. The chute, duct, channel, or the like may then in appropriate ways be connected to one buoyant element of the buoyant body and arranged to slope downward. The closed net cage may, according to this arrangement, be arranged with a closable opening. When the fish are gathered in the closed net cage, the closable opening can be opened, and the fish will be guided from the closed net cage and into the vessel through the chute, duct, channel or the like.

In one aspect, the modular offshore fish farm further comprises a guiding and locking system for the closed net cage and the buoyant body wherein the amount of water and water level inside the closed net cage (2) can be changed after locking the closed net cage and the buoyant body.

In one aspect, when the closed net cage and the buoyant body are locked, the water level in the closed net cage can be increased above the water level of an adjacent closed net cage or a vessel to facilitate transfer via the chute of the fish to another closed net cage or a vessel.

According to one embodiment, each buoyant body may comprise a ballasting and deballasting system in order to be able to position the buoyant body and/or the closed net cage correctly in a body of water.

The modular offshore fish farm may also comprise a pumping system to supply oxygen-rich seawater to each closed net cage.

In one aspect, the water level in the closed net cage is controlled by supplying sea water to the closed net cage from the surrounding sea around the modular offshore fish farm through pipes, at least one pump, at least one filter and a hose, draining sea water from the closed net cage through pipes, at least one pump, at least one filter and a hose.

### DETAILED DESCRIPTION

Other advantages and features of the invention will become apparent from the following detailed description, the accompanying drawings, and the appended claims, wherein:

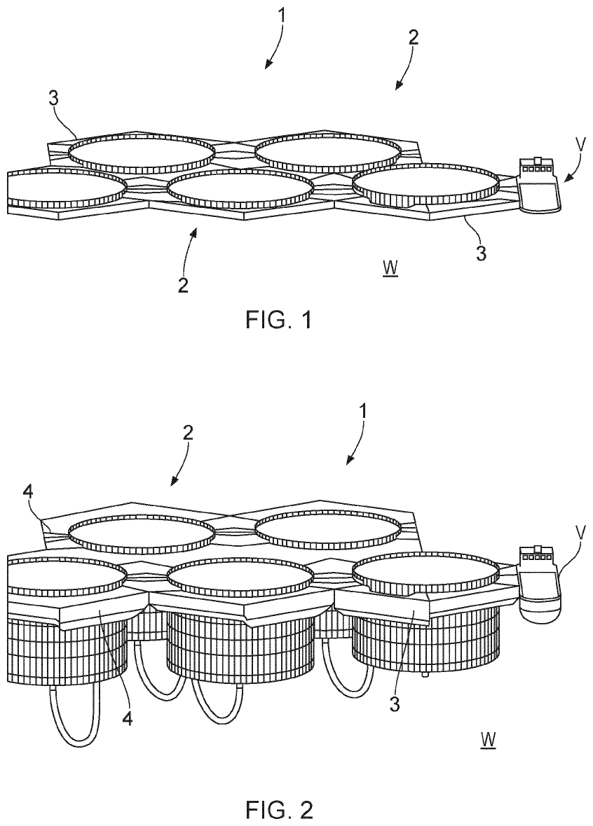

FIG. 1 shows a perspective view of a first exemplary embodiment of a modular offshore fish farm according to the present invention, where a number of buoyant bodies are connected to form the fish farm,

FIG. 2 shows the modular offshore fish farm according to FIG. 1, where a number of closed net cages are arranged in the buoyant bodies,

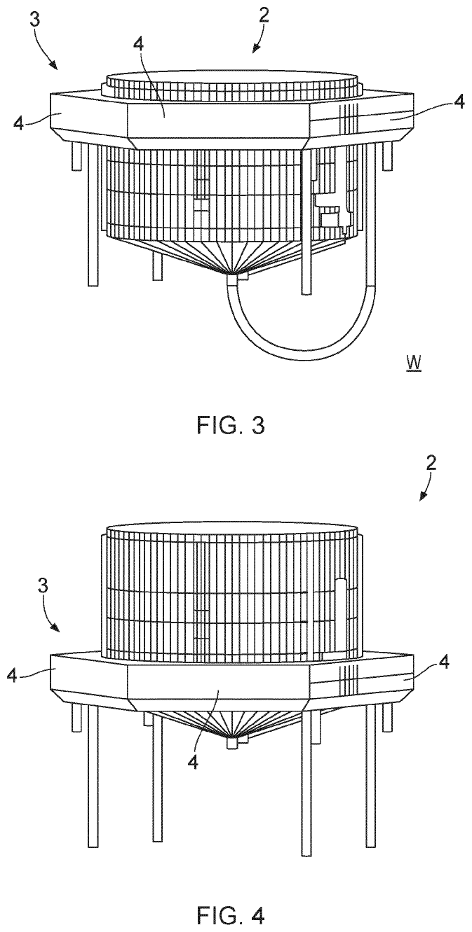

FIG. 3 shows a closed net cage in an operational position,

FIG. 4 shows the net cage according to FIG. 3 in a position where fish are to be emptied from one closed net cage and to a vessel connected to the modular offshore fish farm,

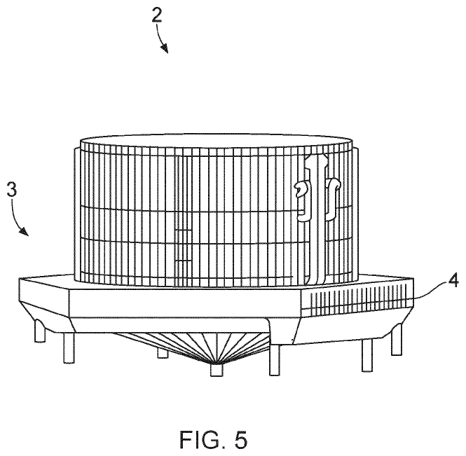

FIG. 5 shows the closed net cage according to FIG. 3 in a transport and maintenance position,

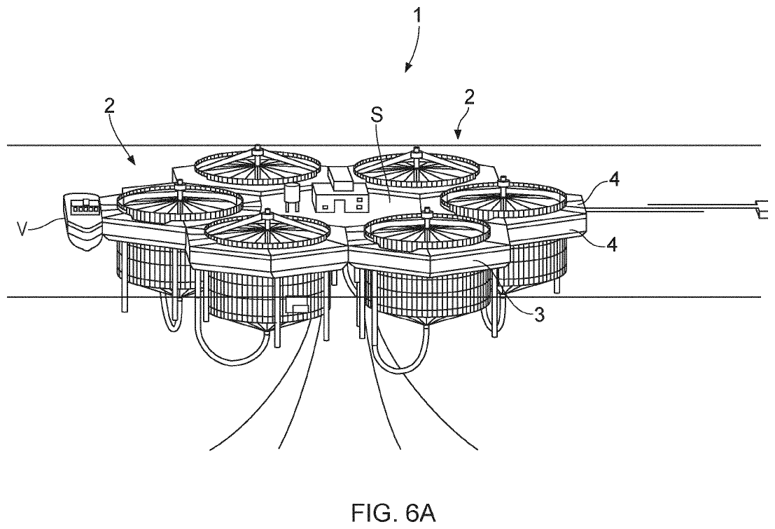

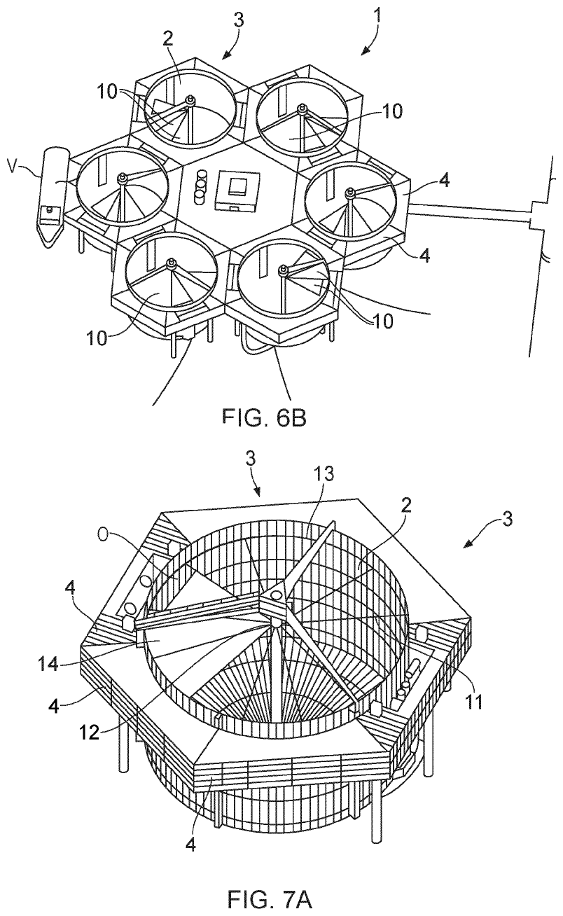

FIG. 6A-6B show an alternative exemplary embodiment of the modular offshore fish farm according to FIG. 1, where FIG. 6A shows the offshore fish farm in a perspective view and FIG. 6B shows the offshore fish farm from above,

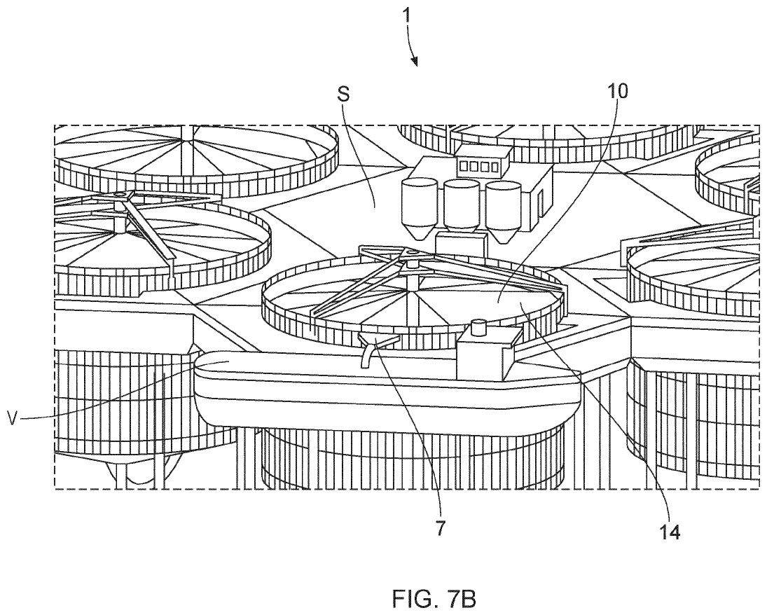

FIG. 7A-7B show a suppressing device for fish according to the present invention, where FIG. 7A shows the suppressing device arranged in an upper position of the closed net cage, and where FIG. 7B shows how the suppressing device in this upper position is used to empty the fish from the closed net cage and to a vessel moored to the closed net cage, through a channel, chute or the like,

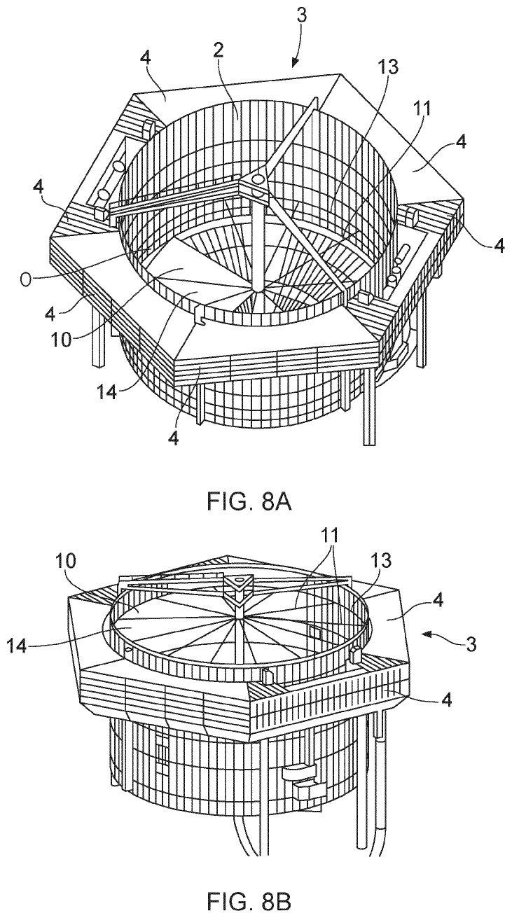

FIG. 8A-8B show the suppressing device arranged in different positions within the fish tank of the modular offshore fish farm,

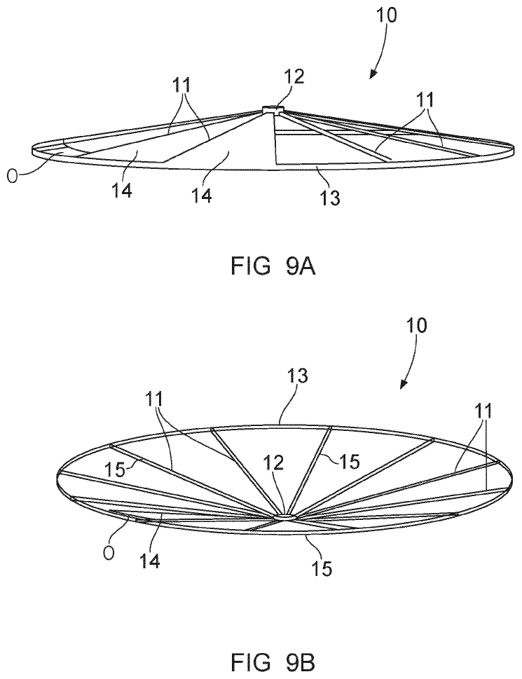

FIGS. 9A-9B show the suppressing device in greater detail, where FIG. 9A shows the suppressing device in an uppermost position and FIG. 9B shows the suppressing device in a lowest position,

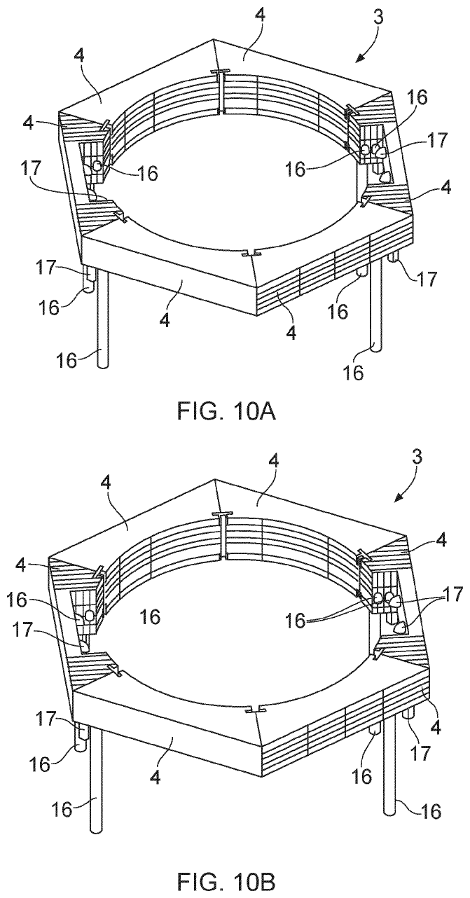

FIGS. 10A-10B show inlets and outlets for water into and out of the fish tank, where FIG. 10A shows how the inlets and outlets are arranged in a buoyant element of a buoyant body, and FIG. 10B shows the arrangement of the pipes etc. inside the buoyant element,

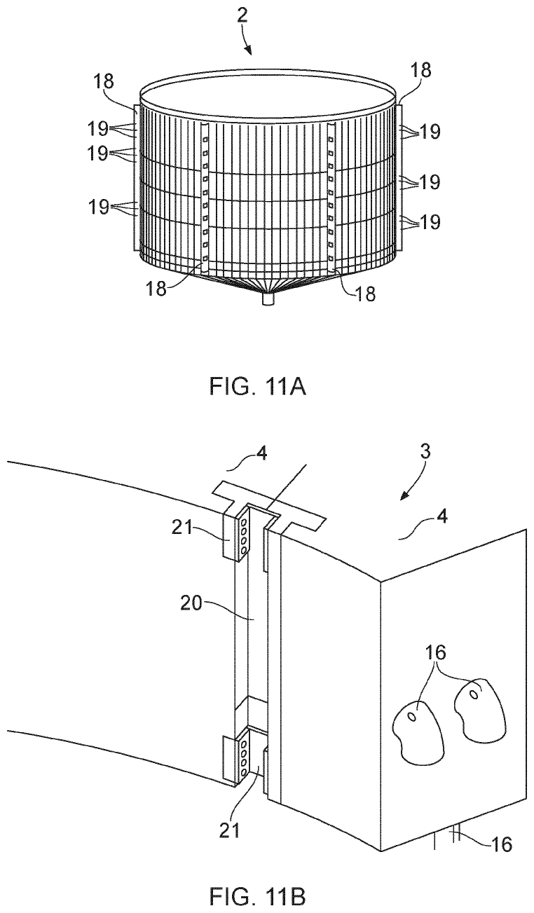

FIGS. 11A-11B show a locking system for the fish tank relative the buoyant body, where FIG. 11A shows rails arranged around an outer periphery of the fish tank, and FIG. 11B shows the locking groove arrange on an inside of a buoyant element of the buoyant body,

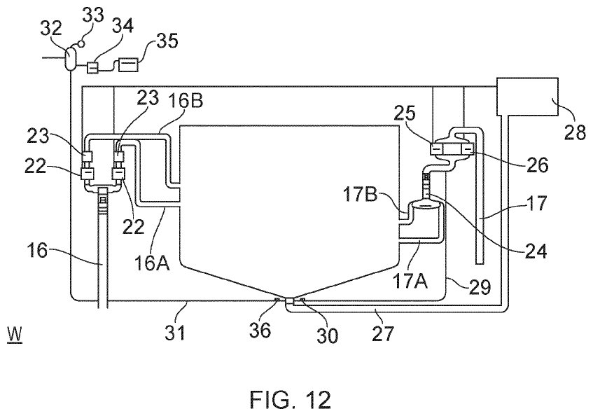

FIG. 12 shows further details of the arrangement connected to the inlets and outlets of the modular offshore fish farm, and

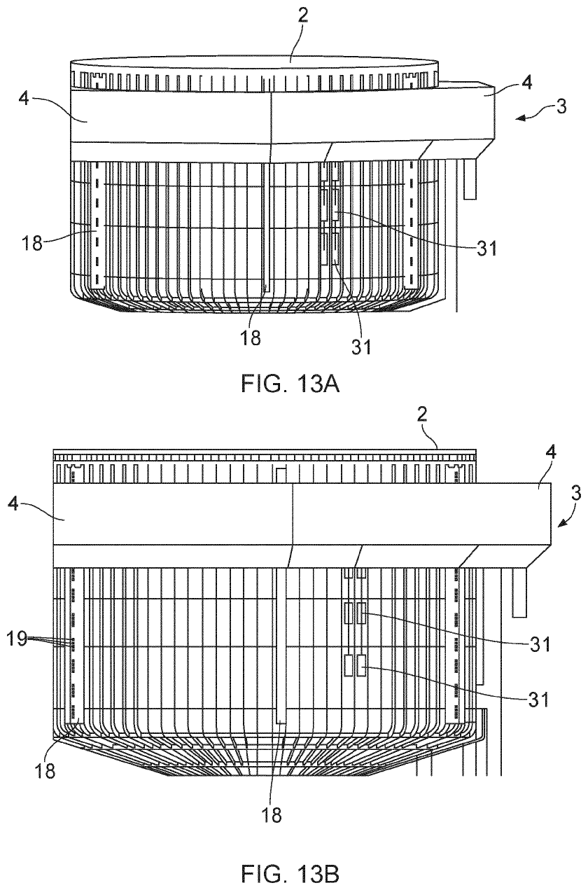

FIGS. 13A-13B show the locking arrangement in greater detail.

FIG. 1 shows a first exemplary embodiment of a modular offshore fish farm 1 according to the present invention, where the modular offshore fish farm 1 comprises five closed net cages 2, each closed net cage 2 being supported by a buoyant body 3 configured for floating in a body of water W.

Each closed net cage 2 comprises a guiding and locking system, where the guiding and locking system allows each closed net cage 2 to be moved relative the buoyant body 3, for instance between an operational position and a transport/maintenance position as well as one or more intermediate positions, and thereafter to be locked in the desired position. One intermediate position may be a position where the fish are to be emptied from the closed net cage 2 and to a vessel connected to the modular offshore fish farm 1, where the vessel V is used to transport the fish to a slaughter plant onshore or the like.

According to the present invention, each closed net cage 2 may be moved up and down in the body of water W relative to the buoyant body 3 by changing the buoyancy of the closed net cage 2, i.e. by changing an amount of water being inside the closed net cage 2. If the closed net cage 2 is to be lowered relative to the buoyant body 3, then an amount of water pumped into the closed net cage 2 will be greater than an amount of water pumped or drained out of the closed net cage 2. Similarly, if the closed net cage 2 is to be lifted relative to the buoyant body 3, then an amount of water pumped or drained out of the closed net cage 2 will be greater than an amount of water pumped into the closed net cage 2.

The vessel may also be used to “store” the fish during maintenance of the closed net cage 2.

If a closed net cage 2 of the modular offshore fish farm 1 is to be maintained, the guiding and locking system will be used to bring the closed net cage 2 to the position where the fish can be emptied from the closed net cage 2, and when the fish, from this position, are transferred to the vessel for temporary “storage” of the fish, the guiding and locking system is used to move the closed net cage 2 further to the maintenance position. When the maintenance of the closed net cage 2 has been carried out, the closed net cage 2 will be lowered again and the fish may be transferred back to the closed net cage 2 again from the vessel, either in the position that allows the emptying of the fish or also in the operational position of the closed net cage 2.

Although FIG. 1 shows a modular offshore fish farm 1, it should be understood that the modular offshore fish farm 1 according to the present invention could comprise fewer or more closed net cages 2 than the five closed net cages 2 according to the exemplary embodiment, for instance, one, two, three, four or six or more closed net cages 2.

Each closed net cage 2 comprises a buoyant body 3 arranged around an outer circumference of the closed net cage 2, where the buoyant body 3 in this exemplary embodiment comprise six buoyant elements 4. When the buoyant element 4 are connected to each other in appropriate ways, the buoyant elements 4 will form a buoyant body 3 with a hexagonal form. However, it should be understood that the buoyant body 3 could comprise a different number of buoyancy elements 4, for instance eight buoyancy elements 4, whereby such a number of buoyancy elements 4 would give a buoyant body 3 with an octagonal form.

Furthermore, each buoyant element 4 of the buoyant body 3 of one closed net cage 2 is, on a side facing away from the closed net cage 2, provided with connecting means, such that the buoyant body 3 of one closed net cage 2, could be connected to a buoyant element 4 of an adjacent buoyant body 3 of a closed net cage 2, in order to form the modular offshore fish farm 1.

According to one embodiment, the buoyant elements 4 may be connected to each other through welding, bolts or the like, in order to be assembled to a buoyant body 3.

Furthermore, each buoyant element 4 may, on one side of the buoyant element 4, be provided with a “tongue”, while an opposite side of the buoyant element 4 is provided with a groove. When the buoyant elements 4 are to be connected to each other, the buoyant elements 4 will be arranged in such a way that a side of a first buoyant element 4 provided with the “tongue” will be arranged adjacent a side of a second buoyant element 4 provided with a groove, such that the “tongue” of the first buoyant element 4 can be connected to the groove of the second buoyant element 4. An opposite side of the second buoyant element 4 is provided with a “tongue”, where the “tongue” of the second buoyant element 4 is to be connected to a side of a third buoyant element 4 provided with a groove. A last buoyant element 4 (i.e. the sixth buoyant element) of the buoyant body 3 is then, on a side facing the first buoyant element 4, provided with a “tongue”, such that the “tongue” of the sixth buoyant element 4 may be connected to the side of the first buoyant element 4 provided with the groove.

When the number of buoyant bodies 3 are connected to each other in order to form the modular offshore fish farm 1, the length and width of the different buoyant elements 4 of the buoyant bodies 3 will provide a working platform between the number of closed net cages 2.

The closed net cages 2 of the modular offshore fish farm 1 according to the present invention may be made from metal, a composite material or combination of these.

The buoyant elements 4 of the buoyant bodies 3 may be made from concrete or a metal. However, it should be envisaged that the buoyant elements 4 could be made from other materials, such as composite materials or could be made from a combination of materials.

Furthermore, it is to be understood that the buoyant elements 4 could be made from different materials.

FIG. 2 shows the modular offshore fish farm 1 according to FIG. 1, where a closed net cage 2 is arranged in each buoyant body 3.

The buoyant elements 4 of each buoyant body 3 are connected together to form the buoyant body 3, whereafter two adjacent buoyant bodies 3 are connected to each other through the connecting means provided on the respective buoyant elements 4 of the buoyant bodies 3.

Furthermore, at least one of the buoyant elements 4 of the buoyant body 3 is, on a side facing the closed net cage 2 provided with a recess for the guiding and locking system such that the closed net cage 2 could be moved and locked substantially vertically relative to the buoyant body 3.

Each closed net cage 2 comprises an annular shaped upper portion with vertical walls and a conical bottom portion in order to create a zone in a lower part of the closed net cage 2 where solid waste, i.e. fodder and faeces could be collected. The conical bottom portion of each closed net cage 2 could furthermore be connected to a pumping system through a hose, pipe or the like in order to transport the solid waste from the closed net cage 2 and to a cleaning system. Such a cleaning system may, for instance, be arranged on a service unit S, service barge or the like.

FIG. 3 shows how a closed net cage 2 of the modular offshore fish farm 1 is arranged in an operational position, where the closed net cage 2 is lowered down into the body of water W, such that only an upper part of the closed net cage 2 is laying above the body of water W.

FIG. 4 shows how the guiding and locking system is used to lift the respective closed net cage 2 to an intermediate position arranged between the operational position and a transport or maintenance position, where the arrangement of the closed net cage 2 in this position will allow fish in the closed net cage 2 to be emptied from the closed net cage 2 to a vessel V connected to the modular offshore fish farm 1, or to another closed net cage 2 of the modular offshore fish farm 1.

When the fish are to be emptied from one closed net cage 2 of the modular offshore fish farm 1, a chute 7, duct, channel or the like is used to guide and transfer the fish from the closed net cage 2 to the vessel V, or to another closed net cage 2 of the modular offshore fish farm 1.

The chute 7, duct, channel, or the like is then in appropriate ways connected to the closed net cage 2 and arranged to slope downward.

The closed net cage 2 will then be provided with a closable opening (not shown). When the fish are gathered and/or suppressed in the closed net cage 2, the closable opening can be opened, and the fish will be guided from the closed net cage 2 and into the vessel V, or into an adjacent closed net cage 2, through the chute 7, duct, channel, or the like, due to gravity.

FIG. 5 shows how a closed net cage 2 of the modular offshore fish farm 1 is arranged when each individual closed net cage 2 is to be transported between two sites, for instance from a building site and to a site where the modular offshore fish farm 1 is to be located, or when a closed net cage 2 is to be maintained during the operation of the modular offshore fish farm 1 or when the fish are to be emptied from a closed net cage 2.

If the closed net cage 2 has to be maintained, the guiding and locking system is used to bring the closed net cage 2 to the position where the fish firstly must be emptied from the closed net cage 2. During this operation, the closed net cage 2 is locked to the buoyant body 3. When the fish have been transferred to the vessel for temporary “storage” of the fish, the guiding and locking system is used to move the closed net cage 2 further up to the maintenance position. When the maintenance of the closed net cage 2 has been carried out, the closed net cage 2 will be lowered again and the fish may be transferred back to the closed net cage 2 again from the vessel, either in the position that allows the emptying of the fish or also in the operational position of the closed net cage 2.

FIGS. 6A-6B show an alternative embodiment of the modular offshore fish farm 1 according to FIG. 1, where the modular offshore fish farm 1 also in this embodiment comprise six closed net cages 2, each closed net cage 2 being supported by a buoyant body 3 configured for floating in a body of water W.

Each closed net cage 2 and buoyant body 3 comprise a guiding and locking system for allowing each closed net cage 2 to be moved relative the buoyant body 3, for instance between an operational position and a transport/maintenance position as well as one or more intermediate positions. One intermediate position may be a position where the fish are to be emptied from the closed net cage 2 and to a vessel connected to the modular offshore fish farm 1, where the vessel V is used to transport the fish to a slaughter plant onshore or the like.

The six closed net cages 2 are arranged around a service unit S, whereby the service unit S is used to serve all the closed net cages 2 in the modular offshore fish farm 1. The service unit S shown in this exemplary embodiment comprises a living quarter for personnel or crew, silos or bunkers for fish feed, oxygenation systems, pumps, and aggregators etc.

The vessel V may also be used to “store” the fish during maintenance of the closed net cage 2.

If a closed net cage 2 is to be maintained, the guiding and locking system will be used to bring the closed net cage 2 to the position where the fish can be emptied from the closed net cage 2, and when the fish have been transferred to the vessel for temporary “storage” of the fish, the guiding and locking system is used to move the closed net cage 2 further to the maintenance position. When the maintenance of the closed net cage 2 has been carried out, the closed net cage 2 will be lowered again and the fish may be transferred back to the closed net cage 2 again from the vessel, either in the position that allows the emptying of the fish or also in the operational position of the closed net cage 2.

It should be understood that the modular offshore fish farm 1 according to the present invention could comprise fewer or more closed net cages 2 than the six closed net cages 2 according to the exemplary embodiment, for instance, one, two, three, four or seven or more closed net cages 2, where the number of closed net cages 2 is to be adapted to the specific location, number of fish, type of fish (smolt or large fish etc.).

Each closed net cage 2 comprises a buoyant body 3 arranged around an outer circumference of the closed net cage 2, where the buoyant body 3 in this exemplary embodiment comprise six buoyant elements 4. When the buoyant element 4 are connected to each other in appropriate ways, the buoyant elements 4 will form a buoyant body 3 with a hexagonal form.

However, it could be envisaged that the buoyant body 3 could comprise a different number of buoyancy elements 4, for instance eight buoyancy elements 4, whereby such a number of buoyancy elements 4 would give a buoyant body 3 with an octagonal form.

Furthermore, each buoyant element 4 of the buoyant body 3 of one closed net cage 2 is, on a side facing away from the closed net cage 2, provided with connecting means, such that the buoyant body 3 of one closed net cage 2, could be connected to a buoyant element 4 of an adjacent buoyant body 3 of a closed net cage 2, in order to form the modular offshore fish farm 1.

When the number of buoyant bodies 3 are connected to each other, the length and width of the different buoyant elements 4 of the buoyant bodies 3 will provide a “working space” between the number of closed net cages 2, where this “working space” may be used to drive vehicles, transport different equipment on etc.

The closed net cages 2 of the modular offshore fish farm 1 according to the present invention may be made from metal, a composite material or combination of these.

The buoyant elements 4 of the buoyant bodies 3 may be made from concrete or a metal. However, it should be envisaged that the buoyant elements 4 could be made from other materials, such as composite materials or could be made from a combination of materials.

Furthermore, it is to be understood that the buoyant elements 4 could be made from different materials.

FIG. 7A shows a suppressing device 10 arranged within a closed net cage 2, where the suppressing device 10 is used to suppress the fish inside the closed net cage 2, for instance when the fish are to be displaced in order to be transferred to a fish carrier in order to be transported to a slaughter plant onshore.

The suppressing device 10 comprises a number of ribs 11 extending between an inner center ring 12 and an outer ring 13, where a net 14 extends between two adjacent ribs 11. The suppressing device 10 will therefore comprise a number of “cake slices”. The inner center ring 12 is connected to a vertically arranged center column in the closed net cage 2, such that the suppressing device 10 can be guided along the center column.

Each of the ribs 11 is provided with a rope (not shown), wire or the like, where two adjacent ribs 11 forms a regulation system for the net (14) extending between these two adjacent ribs 11, such that the net 14 can be adjusted between a closed position (extending to the outer ring 13) and an open position (being arranged between the inner center ring 12 and the outer ring 13), thereby providing an opening between the two adjacent ribs 11.

If the fish are to be collected to be transported to the slaughter plant, one or more of the nets 14 are adjusted to provide an opening O between two adjacent ribs 11 (i.e. a “cake slice”, where the fish may “escape” through this opening when the suppressing device 10 is moved downwards along the center column in the closed net cage 2.

It should be understood that canvas could be used instead of net 14.

When the suppressing device 10 is arranged in the uppermost position, near an upper edge of the closed net cage 2, the suppressing device 10 will have a downwardly facing opening. When the suppressing device 10 is to be moved downwardly along the center column towards the bottom of the closed net cage 2, firstly one or more nets 14 are adjusted to provide openings O in a number of “cake slices”, such that fish can move through the opening, from an underside of the suppression device 10 and to an upper side of the suppression device 10.

During the movement of the suppressing device, from the uppermost position to the lowest position in the closed net cage 2, the suppressing device 10 will undergo a change in the form, as the suppressing device 10 will be moved from a downwardly open position to an upwardly open position.

FIG. 7B shows the suppressing device 10 in the uppermost position, where the fish, through the movement of the suppressing device 10 from the bottom of the closed net cage 2 to the uppermost position have moved through the one or more openings O provided in one or more of “cake slices”, whereafter the nets 14 of the respective “cake slices” are moved towards the outer ring 13 in order to form a closed suppressing device 10. Furthermore, in this uppermost position, the suppressing device 10 will have a downwardly facing opening (i.e. the inner center ring 12 will be arranged above the outer ring 13).

When the fish being in the volume delimited by the vertical walls of the closed net cage 2 and the suppressing device 10 are to be transferred to the vessel V moored to the closed net cage 2, one opening or hatch (not shown) provided in the vertical wall of the closed net cage 2 is opened. The fish will then, due to the form of the suppressing device 10 and the gravity, be transferred to the vessel V more gently, without pumps or the like, through the chute 7, duct, channel or the like.

FIG. 8A shows the suppressing device 10 in a lowermost position (i.e. near the bottom of the closed net cage 2), where one or more of the “cake slices” has been opened (i.e. the net 14 has been moved towards the inner center ring 13, thereby providing an opening O between the inner circumference of the closed net cage 2 and the edge of the net 14 of this “cake slice”, such that fish may be “sucked” and/or swim through this opening O in order to be located above the suppressing device 10. When the suppressing device 10 is in its lowermost position, the nets 14 in the “cake slices” that are provided with the opening O will be moved towards the outer ring 13 in order to close the “cake slices”. In this lowermost position, the suppressing device 10 will have an upwardly facing opening (i.e. the inner center ring 12 will be arranged below the outer ring 13).

When the openings O are closed, the suppressing device 10 is again moved towards its uppermost position. During this movement of the suppressing device 10, the suppressing device 10 will shift its form, from an upwardly facing opening, to a downwardly facing opening, as shown in FIG. 8B. When the suppressing device 10 is located in its uppermost position, the transfer of fish may be finished or carried out as described in accordance with FIG. 7B.

Each of the inner center ring 12 and the outer ring 13 of the suppressing device 10 is connected to a winch system, where each winch system comprises a number of wires (not shown) arranged in such a way to allow the suppressing device 10 to be moved and/or adjusted up and down in the closed net cage 2.

Furthermore, the winch system allow an independent positioning of the inner center ring 12 and the outer ring 13, such that, for instance, the inner center ring 12 may be positioned above or below the outer ring 13, depending on whether the suppressing device 10 is to have a downwardly open position (as shown in FIG. 9A) or an upwardly open position (as shown in FIG. 9B).

During the movement of the suppressing device, from the uppermost position to the lowest position in the closed net cage 2, the suppressing device 10 will undergo a change in the form, as the suppressing device 10 will be moved from a downwardly open position to an upwardly open position, by controlling the winch system of the inner center ring 12 and the outer ring 13 separately or independently of each other.

When running the winch systems at the same speed, the inner center ring 12 and outer ring 13 will not move relative to each other.

For the sake of simplicity, the figures shown only one or two “cake slices” of the suppressing device 10, but it should be understood that the suppressing device 10 comprises a number of “cake slices” that will cover the entire cross sectional area of the closed net cage 2.

FIGS. 9A-9B show the suppressing device 10 in greater detail, where it can be seen that the suppressing device 10 comprises a number of ribs 11 extending between the inner center ring 12 and the outer ring 13. A net 14 is arranged between two adjacent ribs 11, where the net 14 through ropes (not shown), wires or the like may be moved between the inner center ring 12 and the outer ring 13 in order to provide the opening O in this “cake slice”. The size of the opening O may be adjusted by moving the net 14 either closer to the inner center ring 12 or closer to the outer ring 13.

Furthermore, the outer periphery of the outer ring 13 may be provided with cleaning means 15, where the cleaning means 15 are used to clean the inner periphery of the closed net cage 2 when the suppressing device 10 is moved up and down in the closed net cage 2.

The cleaning means 15 may comprise scrapes, brushes or the like in order to remove sprout, algae etc. from the walls of the closed net cage 2.

Similarly, an inner periphery of the inner center ring 12 may be provided with cleaning means 15, where the cleaning means 15 are used to clean the outer periphery of the center column when the suppressing device 10 is moved up and down in the closed net cage 2.

In one embodiment the suppressing device 10 may also be arranged to rotate about the center column, in order to be able to clean the bottom of the closed net cage 2. The suppressing device 10 may then, for instance through a gear system or the like, be arranged to rotate, for instance, 10 to 30 degrees to each side of the center column, from a specified starting point. The ribs 11 may then be provided with cleanings means 15 for cleaning the bottom surface of the closed net cage 2. When the suppressing device 10 is rotated, the whole bottom surface may be cleaned by the cleaning means 15 on the ribs 11.

FIG. 9A shows the suppressing device 10 with a downwardly facing opening (i.e. when the suppressing device 10 is arranged in the uppermost position in the closed net cage 2), while FIG. 9B shows the suppressing device 10 with an upwardly facing opening (i.e. when the suppressing device 10 is arranged in the lowermost position in the closed net cage 2).

However, sometimes for various reasons, it is not desirable to empty the entire closed net cage 2 for fish, whereby the suppressing device 10 in such an embodiment may be arranged in such a way that the suppressing device 10 may provide an “air pocket” in the suppressing device 10 when the suppressing device 10 is arranged in an downwardly open position (as shown in FIG. 9A). Each net 14 extending between two adjacent ribs 11 and forming a “cake slice” in the suppressing device 10, may then be provided as to be at least partly air impermeable over its length. Each of the nets may, for instance, be air impermeable from the inner center ring 12 and half of its length (i.e. half the length of a distance between the inner center ring 12 and the outer ring 13.

The center column may then be provided with a plurality of openings and/or nozzles for air along a longitudinal length of the center column, where the openings and/or nozzles through pipes, hoses or the like are connected to an oxygenation system arranged, for instance, on the service unit S.

The oxygenation system may then be used to pump down oxygen below the inner center ring 12 of the suppressing device 10, whereby this oxygen will rise when fed into the water inside the closed net cage 3. As the nets 14 of “cake slices” of the suppressing device 10 are provided to be air impermeable in an area close to the inner center ring and the center column arranged within the closed net cage 2, and the suppressing device 10 has a downwardly open position, the oxygen will be entrapped in the upper part of the suppressing device 10, whereby fish located below the suppressing device may fill their swim bladder with oxygen from the “air pocket” provided and entrapped within the suppressing device 10.

FIGS. 10A-10B show an exemplary embodiment of buoyant body 3 according to the present invention, where the buoyant body 3 comprises four buoyant elements 4 connected to each other in appropriate ways, for instance welding and/or bolts (not shown) in order to provide the buoyant body 3. Two of the buoyant elements 4 are ballastable/deballastable, while the remaining two buoyant elements 4 comprises arrangement of pipes for supply of fresh sea water to the closed net cage 2 and arrangement of pipes for drainage of sea water from the closed net cage 2.

In this embodiment each of the two buoyant elements 4 comprise two pipes 16 for supply of fresh sea water and two pipes 17 for drainage of sea water from the closed net cage 2.

An outlet for fresh sea water of each pipe 16 is then connected to an end of a flexible hose (not shown), where an opposite end of the flexible hose is connected to an inlet for fresh sea water provided in the closed net cage 2. Similarly, an inlet for sea water from the closed net cage 2 of each pipe 17 is connected to an end of a flexible hose (not shown), where an opposite end of the flexible hose is connected to an outlet for sea water from the closed net cage 2 provided in the closed net cage 2. Through this arrangement of the pipes 16, 17, the flexible hoses and the inlets for fresh sea water and outlet for sea water from the closed net cage 2, it is obtained that the closed net cage 2 can be moved relative the buoyant body 3.

FIGS. 11A-11B show a guiding and locking system for the closed net cage 2 and the buoyant body 3 arranged around the closed net cage 2, where FIG. 11A shows that the closed net cage 2 is provided with a number of spaced apart beams 18, rails or the like around it outer circumference, where each beam 18, rail or the like is provided with a number of throughgoing holes 19 along its length. In this exemplary embodiment each beam 18, rail or the like is provided with a number of groups of throughgoing holes 19, where each group of holes 19 comprises four throughgoing holes 19.

FIG. 11B shows how the buoyant elements 4 of the buoyant body, on an inside is provided with a vertically extending groove 20 or slit, where a locking unit 21 is arranged in the vertically extending groove 20 or slit near both an upper end and a lower end of the buoyant element 4. The locking unit 21 is in appropriate ways fixed to the groove 20 or slit.

When the buoyant body 3 is arranged around the closed net cage 2, each of the beams 18, rails or the like of the of the closed net cage 2, is accommodated in the corresponding groove 20 or slit of the buoyant body 3.

The locking unit 21 comprises in this embodiments four bolts (not shown), where the bolts are adapted to the throughgoing holes 19 provided in the beams 18, rails or the like of the closed net cage 2, such that the bolts may be extended into the throughgoing holes 19 when the closed net cage 2 is to be locked to the buoyant body 3 in a specific position, for instance in an operation position as shown in FIG. 3 or in a maintenance or transport position as shown in FIG. 5.

FIG. 12 shows in greater detail a pumping and cleaning system connected to the pipes 16 for supply of fresh water and pipes 17 for drainage of sea water from the closed net cage 2, where the pumping and cleaning system is arranged in a buoyant element 4 of the buoyant body 3.

The pipe 16 for supply of fresh water may be extendable, in order to pump up fresh sea water with a certain temperature, a certain salinity and/or to pump up sea water free for sea lice. The pipe 16 may be connected to one or more pumps 22 and one or more filters 23.

In this exemplary embodiment the pipe 16 for supply of fresh water is branched off in two pipes 16A, 16B, where each of the two pipes 16A, 16B is connected to the pumping and filtering system. In this embodiment the pumping and cleaning system comprises at least one pump 22 and at least one filter 23.

Furthermore, an outlet of each of the two pipes 16A, 16B is connected to a flexible hose (not shown), where an opposite end of the flexible hose is connected to an inlet for fresh sea water provided in the closed net cage 2.

The pipe 17 for drainage of sea water from the closed net cage 2 is in a similar branched off in two pipes 17A, 17B, where each of the two pipes 17A, 17B is connected to another pumping and filtering system, where the pumping and cleaning system comprises at least one pump 24 and at least one filter 25, 26.

An inlet for sea water from the closed net cage 2 of each pipe 17A, 17B is connected to an end of a flexible hose (not shown), where an opposite end of the flexible hose is connected to an outlet for sea water from the closed net cage 2 provided in the closed net cage 2.

Through this arrangement of the pipes 16A, 16B and 17A, 17B, the flexible hoses and the inlets for fresh sea water and outlet for sea water from the closed net cage 2 it is obtained that the closed net cage 2 can be moved relative the buoyant body 3.

The bottom of the closed net cage 2 may be connected to a pipe 27, where the pipe extends from the closed net cage 2 and to a settling tank 28 arranged on the modular offshore fish farm 1, for instance on the service unit S. Through this arrangement the solid waste collected on the bottom of the closed net cage 2 may be removed from the closed net cage 2 and collected in the settling tank 28 in order to be processed further.

The closed net cage 2 may also be connected to an additional pipe 29, where this pipe 29 may be used if the closed net cage 2 for some reason needs to be emptied, for instance when the closed net cage 2 is to be maintained, transported from one site to another, the fish are to undergo a treatment or the like. A valve 30 connected to the additional pipe 29 may be opened and the sea water from the closed net cage 2 will then be led to the pumping and filtering system for drainage of sea water in order to be cleaned before the cleaned sea water is returned to sea through the pipe 17.

Similarly, the closed net cage 2 may also be connected to yet an additional pipe 31, where the pipe 29 may be used when dead fish from the closed net cage 2, the dead fish being accumulated at the bottom of the closed net cage 2, is to be removed from the closed net cage 2. The additional pipe 31 is connected to at least one vacuum tank 32, where the at least one vacuum tank 32 is connected to a control and driving unit 33 and to a milling and/or grinding device 34 which in turn is connected to an ensiling device 35. A valve 36 connected to the additional pipe 31 may be opened if needed and the at least one vacuum tank 32 will “suck” out the dead fish from the closed net cage 2, whereafter the dead fish etc. is transported to the milling and/or grinding device 34. When the dead fish have been treated in the mill and/or grinding device 34, the residual waste will be sent to the ensiling device 35.

FIGS. 13A-13B show how the closed net cage 2 may be provided with a plurality of closeable hatches 31, doors or the like around it periphery, where these closeable hatches 31, doors or the like may be opened manually, without use of electric power. FIG. 13A shows the hatches 31, doors or the like in an open state, while FIG. 13B shows the hatches 31, doors or the like in a closed state.

In one embodiment the closed net cage 2 may be provided with a plurality of adjustable nozzles (not shown) around its inner periphery and along the height of the walls, where the adjustable and/or rotatable nozzles are used to provide a water current within the closed net cage 2, creating either a water current in a direction the fish within the closed net cage 2 are used to follow, or even a counter-current for a period of time, for instance when new fish are introduced in the closed net cage 2.

The invention has now been explained with several non-limiting examples. One skilled in the art will appreciate that a variety of variations and modifications may be made to the modular offshore fish farm as described within the scope of the invention as defined in the appended claims.

1. A modular offshore fish farm comprising
one or more closed net cages and
a service unit,
wherein each closed net cage is supported by a buoyant body which is configured for floating in a body of water,
wherein
each closed net cage is configurated for moving vertically in a body of water relative to the buoyant body by changing the buoyancy of the closed net cage by changing the amount of water inside the closed net cage,
each buoyant body further comprising a number of buoyant elements and connecting means for connecting to an adjacent buoyant body,
at least one buoyant element of a buoyant body being arranged to be ballastable/deballastable, and
at least one buoyant element comprises one or more pipes for supply of sea water and drainage of sea water from the closed net cage, and
a pumping and cleaning system connected to the one or more pipes.

2. The modular offshore fish farm according to claim 1, wherein each closed net cage comprises an annular shaped upper portion with vertical walls and a conical bottom portion.

3. The modular offshore fish farm according to claim 1 or 2, wherein a pipe through one end is connected to the conical bottom portion of the closed net cage and through an opposite end is connected to a settling tank.

4. The modular offshore fish farm according one or more of the preceding claims, wherein the pumping and cleaning system comprises one or more pumps.

5. The modular offshore fish farm according to claim 1, wherein pumping and cleaning system comprises one or more filtering units.

6. The modular offshore fish farm according to claim 1, wherein the modular offshore fish farm comprises at least one chute, duct or channel for transporting fish.

7. The modular offshore fish farm according to claim 1, wherein the modular offshore fish farm further comprises a guiding and locking system for the closed net cage and the buoyant body,
wherein the amount of water and water level inside the closed net cage can be changed after locking the closed net cage and the buoyant body.

8. The modular offshore fish farm according to claim 7, wherein the locking system comprises a number of spaced apart beams or rails arranged around an outer circumference of the closed net cage and a locking unit arranged in a vertically extending groove in a buoyant element.

9. The modular offshore fish farm according to claim 7 or 8, wherein each beam or rails is provided with a number of throughgoing holes along a length of the beam or rail, and that the locking unit comprises a number of extendable and retractable bolts.

10. The modular offshore fish farm according to claim 1, wherein an additional pipe is connected between the closed net cage and the pumping and cleaning system for drainage of sea water from the closed net cage.

11. The modular offshore fish farm according to claim 1, wherein a pipe for dead fish is connected to the conical bottom portion of the closed net cage and at least one vacuum tank, the vacuum tank further being connected to a milling and/or grinding device which in turn is connected to an ensiling unit.

12. The modular offshore fish farm according to claim 11, wherein a valve is connected to the pipe for dead fish and a control unit.

13. The modular offshore fish farm according to claim 1, wherein the service unit comprises a building, different equipment, or the like.

14. The modular offshore fish farm according to claim 1, wherein the water level in the closed net cage is controlled by:
supplying sea water to the closed net cage from the surrounding sea around the modular offshore fish farm through pipes, at least one pump, at least one filter and a hose,
draining sea water from the closed net cage through pipes, at least one pump, at least one filter and a hose.
